(19) United States
(12) Patent Application Publication
(10) Pub. No.: US 2022/0290044 A1
(43) Pub. Date: Sep. 15, 2022

(54) ROOM TEMPERATURE PHOSPHORESCENT METAL-FREE CARBON DOTS IN A CONTINUOUS SILICA NETWORK AND METHODS OF MAKING

(71) Applicants: University of Connecticut, Farmington, CT (US); South China Agricultural University, Guangzhou (CN)

(72) Inventors: Mingtao ZHENG, Guangzhou (CN); Yingliang LIU, Guangzhou (CN); Yuqiong SUN, Guangzhou (CN); Shuting LIU, Farmington, CT (US); Luyi SUN, Farmington, CT (US)

(21) Appl. No.: 17/689,329

(22) Filed: Mar. 8, 2022

Related U.S. Application Data
(60) Provisional application No. 63/158,650, filed on Mar. 9, 2021.

(51) Int. Cl. C09K 11/65; C09K 11/02; C01B 32/166

(52) U.S. Cl. CPC C09K 11/65; C09K 11/025; C01B 32/166; C01P 2004/04; C01P 2004/64; C01P 2004/80; C01P 2006/60

(57) ABSTRACT

Room temperature phosphorescent metal-free carbon dots (CDs) embedded in a continuous SiO₂ network (CDs@SiO₂) are made by a method comprising in part grinding biomass and a source of SiO₂ into a powder and soaking the powder with an acidic aqueous solution; washing the powder with deionized water; reacting the powder with an alkaline aqueous solution to form an aqueous solution of CDs from the biomass and Na₂SiO₃ from the source of SiO₂; lowering the pH of the aqueous solution to a value sufficient to cause gelation; and aging the aqueous solution so that the Na₂SiO₃ forms mono-silicic acid (H₄SiO₄), which polymerizes to form a continuous SiO₂ network composed of Si—O tetrahedrons (gel). The method can further comprise calcination of the CDs, wherein the CDs are multi-confined by a continuous SiO₂ network composed of Si—O tetrahedrons. The metal-free CDs are useful in anti-counterfeiting encryption and fingerprint detection systems.

### CROSS REFERENCE TO RELATED APPLICATION

This non-provisional patent application claims benefit of U.S. Provisional Application No. 63/158,650 filed Mar. 9, 2021 and is incorporated herein by reference in its entirety.

### TECHNICAL FIELD

This disclosure relates to room temperature phosphorescent metal-free carbon dots encapsulated in a continuous silica network, methods of making, and applications thereof.

### BACKGROUND

It is difficult to achieve room temperature phosphorescence (RTP) with both long afterglow lifetime and high phosphorescence quantum efficiency (PQE). Traditional inorganic RTP phosphors exhibit long afterglow lifetimes. The long afterglow lifetimes are a consequence of charge traps arising from structural defects or impurities and from the exciton transition process, where phosphorescence emission is caused by slow release of trapped charge by ambient temperature thermal disturbance. However, given the scarcity of the metal precursors, complex fabrication processes, and extreme instability of the inorganic RTP phosphors in humid environments, none of these inorganic RTP phosphors are of practical use. Although some progress has been made in the development of organic RTP phosphors, these materials suffer from afterglow lifetimes of only milliseconds, low PQE, and low stability, which also significantly limits potential applications. There remains a need in the art for organic RTP phosphors having a long afterglow lifetime, high PQE, and high chemical stability.

### SUMMARY

A method of making room temperature phosphorescent metal-free carbon dots (CDs) embedded in a continuous SiO₂ network (CDs@SiO₂) comprises: grinding biomass and a source of SiO₂ into a powder and soaking the powder with an acidic aqueous solution; washing the powder with deionized water; reacting the powder with an alkaline aqueous solution to form an aqueous solution of CDs from the biomass and Na₂SiO₃ from the source of SiO₂; adjusting the pH of the aqueous solution to 6 or less; aging the aqueous solution so that the Na₂SiO₃ forms mono-silicic acid (H₄SiO₄), which polymerizes to form a continuous SiO₂ network composed of Si—O tetrahedrons (gel); and washing the gel with deionized water and a water-soluble organic solvent, drying, and optionally grinding the metal-free CDs. The method can further comprise calcination of the metal-free CDs, wherein the CDs are multi-confined by a continuous SiO₂ network composed of Si—O tetrahedrons.

This disclosure extends to compositions comprising room temperature phosphorescent metal-free carbon dots (CDs) embedded in a continuous SiO₂ network (CDs@SiO₂) made by the methods disclosed herein. The CDs@SiO₂ can exhibit at least one of: an average lifetime τ_{avg} of about 1 to about 50 s, measured at an excitation wavelength of 260 nm and an emission wavelength of 464 nm by fluorescence spectroscopy; an average lifetime τ_{avg} of about 20 s to about 100 s, measured at an excitation wavelength of 254 nm by visual inspection; or a phosphorescence quantum efficiency of about 20% to about 40%, measured at an excitation wavelength of 260 nm and an emission wavelength of 464 nm by fluorescence spectroscopy.

The room temperature phosphorescent metal-free carbon dots (CDs) embedded in a continuous SiO₂ network (CDs@SiO₂) are useful in time-resolved anti-counterfeiting encryption systems and fingerprint detection systems.

### BRIEF DESCRIPTION OF THE DRAWINGS

The patent or application file contains at least one drawing executed in color. Copies of this patent or patent application publication with color drawings will be provided by the USPTO upon request and payment of the necessary fees.

Exemplary embodiments of the room temperature phosphorescent metal-free carbon dots (CDs) embedded in a continuous SiO₂ network (CDs@SiO₂) and method of making are further described with reference to the appended figures. The various features, method steps and combinations of features/method steps described herein and illustrated in the figures can be arranged and organized differently to result in embodiments which are still within the scope of the present disclosure.

FIG. 1A illustrates schematically the energy level diagram of CDs@SiO₂ illustrating excitation and fluorescence of “naked” carbon dots (left), room temperature phosphorescence of carbon dots in a silica gel matrix (center), and room temperature phosphorescence of carbon dots multi-confined by a continuous SiO₂ network composed of Si—O tetrahedrons (right).

FIG. 1B illustrates schematically encapsulation of carbon dots by Si—O tetrahedrons in which the carbon dots are multi-confined by the continuous SiO₂ network. The multi-confinement effect results in ultralong cyan phosphorescence after exposure to UV light.

FIG. 2 illustrates schematically a method for making metal-free CDs@SiO₂ from rice husks.

FIG. 3 illustrates schematically a method for making metal-free CDs@SiO₂ from rice husks with nitrogen doping.

FIG. 4A illustrates schematically an arrangement of carbon dots and Si—O tetrahedrons prior to gelation, providing no phosphorescence (left); an arrangement of carbon dots and Si—O tetrahedrons after gelation, providing weak phosphorescence (center); and an arrangement of carbon dots and Si—O tetrahedrons after calcination, in which the carbon dots are multi-confined by a continuous SiO₂ network composed of Si—O tetrahedrons, providing strong, ultralong phosphorescence (right).

FIG. 4B illustrates schematically examples of hydrogen bonding and covalent bonding of the continuous SiO₂ network composed of Si—O tetrahedrons to a carbon dot. FIG. 4B, left, also illustrates a fluorescence spectrum, obtained under UV light, and FIG. 4B, right, also depicts a phosphorescence spectrum, obtained after removal of UV light.

FIG. 5A depicts the phosphorescence spectra of CDs@SiO₂ calcined at temperatures from 400 to 700° C.

FIG. 5B depicts the time-resolved phosphorescence decay spectra of CDs@SiO₂ calcined at temperatures from 400 to 700° C.

FIG. 6 is composite of photos of CD@SiO₂ powders derived from gel without calcination in daylight (left), under UV light (254 nm, second from left), and at 1 s, 2 s, and 3 s intervals after switching off the UV light (254 nm).

FIG. 7 is composite of photos of CD@SiO₂ powders calcined at different temperatures in daylight (first column), under UV light (254 nm, second column), and at timed intervals after switching off the UV light (254 nm, third through seventh columns). The photos of CD@SiO₂ powders calcined at a specific temperature are arranged in horizontal rows.

FIG. 8A depicts phosphorescence spectra for CDs@SiO₂, calcined at 600° C., in the presence of strong oxidants.

FIG. 8B depicts phosphorescence spectra for CDs@SiO₂, calcined at 600° C., in the presence of solvents.

FIG. 8C depicts phosphorescence spectra for CDs@SiO₂, calcined at 600° C., at pH values of 2 to 14.

FIG. 8D depicts time-resolved phosphorescence decay spectra of CDs@SiO₂, calcined at 600° C., in the presence of strong oxidants.

FIG. 8E depicts time-resolved phosphorescence decay spectra for CDs@SiO₂, calcined at 600° C., in the presence of polar solvents.

FIG. 8F depicts time-resolved phosphorescence decay spectra for CDs@SiO₂, calcined at 600° C., at pH values of 2 to 14.

FIG. 8G is a plot of normalized phosphorescence intensity for CDs@SiO₂, calcined at 600° C., as a function of pH.

FIG. 8H is a bar chart of lifetimes of CDs@SiO₂, calcined at 600 at ° C., in the presence of oxidants, solvents, and at pH values of 2 to 14.

FIG. 8I is a composite of photographs showing the effect of strong oxidants (left), solvents (center), and pH (right) on CD@SiO₂ powders, calcined at 600 at ° C. The powders are seen settled on the bottom of the UV cuvettes with the supernatant test solutions above the powder.

### DETAILED DESCRIPTION

The present inventors have developed room temperature phosphorescent (RTP) metal-free carbon dots (CDs) embedded in a continuous SiO₂ network (CDs@SiO₂) and methods for making same. Advantageously, the CDs@SiO₂ are metal-free, exhibit ultralong afterglow lifetimes (seconds versus milliseconds), high PQE, and excellent stability. Stability manifests itself in resistance to strong oxidants, solvent resistance, and stability over a pH range of 1 to 14.

The method of making the room temperature phosphorescent metal-free carbon dots (CDs) embedded in a continuous SiO₂ network (CDs@SiO₂), comprises: grinding biomass and a source of SiO₂ into a powder and soaking the powder with an acidic aqueous solution; washing the powder with deionized water; reacting the powder with an alkaline aqueous solution to form an aqueous solution of CDs from the biomass and Na₂SiO₃ from the source of SiO₂; adjusting the pH of the aqueous solution to 6 or less; aging the aqueous solution so that the Na₂SiO₃ forms mono-silicic acid (H₄SiO₄), which polymerizes to form a continuous SiO₂ network composed of Si—O tetrahedrons (gel); and washing the gel with deionized water and a water-soluble organic solvent, drying, and optionally grinding the metal-free CDs.

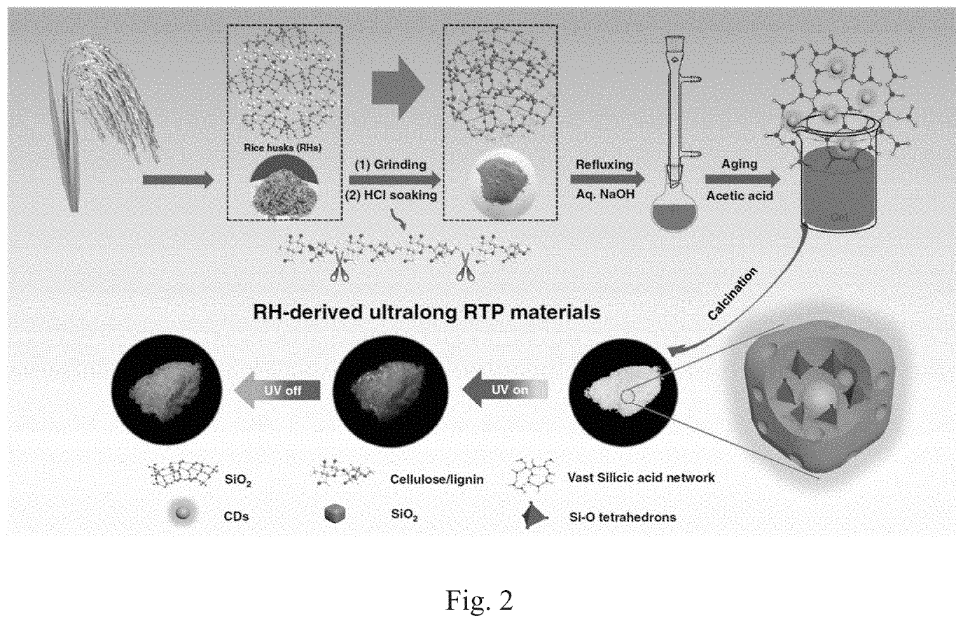

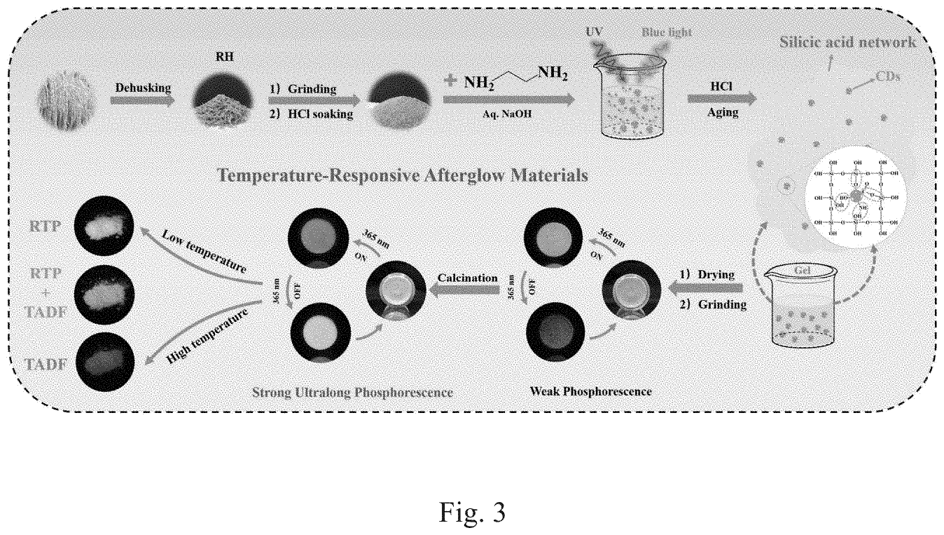

The method requires a source of SiO₂. In some embodiments, the source of SiO₂ is at least one of silica gel, fused quartz, fumed silica, sodium metasilicate, potassium metasilicate, sodium orthosilicate, or sodium pyrosilicate. In other embodiments of the method, the biomass is a silicon-rich biomass, which also serves as the source of SiO₂. The silicon-rich biomass can be, for example, at least one of rice husks, wheat bran, diatoms, bamboo leaves, bamboo shoot shells, rice straw, corn stalk, oat stalk, barley awns, rice straw, indocalamus leaves, reed leaves, or siliceous spicules. In some embodiments, the silicon-reach biomass comprises rice husks. FIG. 2 illustrates schematically a method for making RTP metal-free CDs@SiO₂ where the biomass is rice husks. FIG. 2, top left to right, illustrates the steps of collection of the rice husks, grinding the rice husks into a powder and soaking the powder with an acidic solution. The acidic solution can be an aqueous hydrochloric acid (HCl) solution. This step serves in part to hydrolyze cellulose in the rice husks as illustrated schematically by scissors. After washing the powder with deionized water, the next step is reacting the powder with an alkaline aqueous solution. The aqueous alkaline solution can be, for example an aqueous sodium hydroxide (NaOH) solution. Reacting at a temperature of at least 160° C. under alkaline conditions is effective in converting organic compounds and biopolymers like cellulose in the biomass to carbon dots. In some embodiments, the reacting is done at about 160 to about 180° C. At the same time, the source of SiO₂ is converted into sodium metasilicate (Na₂SiO₃) according to Equation (1) below. Thus, the powder is reacted with an alkaline aqueous solution to form an aqueous solution of CDs from the biomass and Na₂SiO₃ from the source of SiO₂.

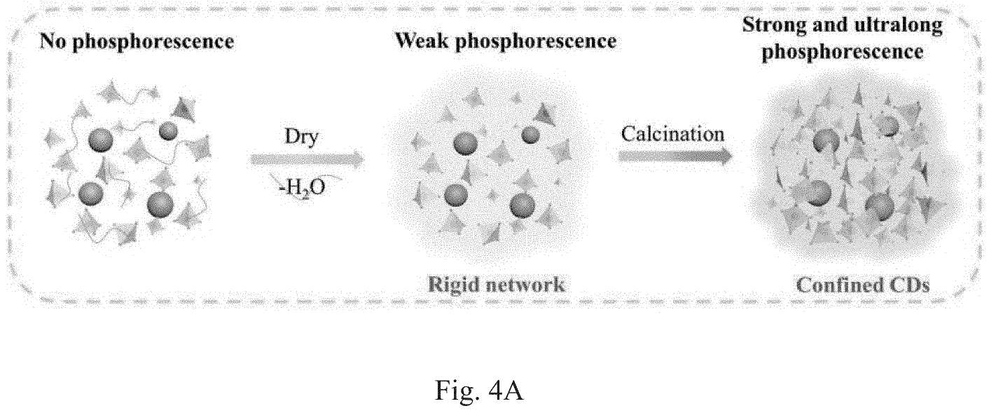

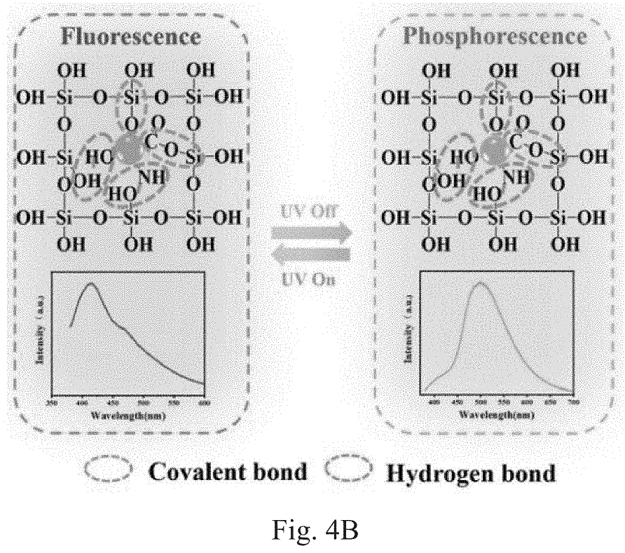

The next step is lowering the pH of the aqueous solution to a value sufficient to cause gelation. Any organic or mineral acid strong enough to lower the pH of the alkaline solution to a value sufficient to cause gelation can be used. The pH sufficient to cause gelation can be 9 or less, 8 or less, 7 or less, or 6 or less. The pH sufficient to cause gelation can be a range of values and a function of several factors. For example, in the presence of a polyamine, such as EDA, the pH sufficient to cause gelation can be about 9. In the absence of a polyamine or other basic organic compound, the pH sufficient to cause gelation can be about 6. In some embodiments, acetic acid (HAc) is used to lower the pH, as in Example 1 herein. Aqueous HCl can be used in place of HAc as in Example 3 herein. When HAc is used to lower the pH to a value sufficient to cause gelation, mono-silicic acid (H₄SiO₄) is formed by reaction of sodium metasilicate Na₂SiO₃ with acetic acid (HAc) according to Equation (2) above. The mono-silicic acid (H₄SiO₄) polymerizes to form a continuous SiO₂ network composed of Si—O tetrahedrons (gel) according to Equation (3) above. The complexation of carbon dots by a continuous SiO₂ network in the gel is illustrated schematically in the upper right of FIG. 2, the right side of FIG. 3, and the central part of FIG. 4A.

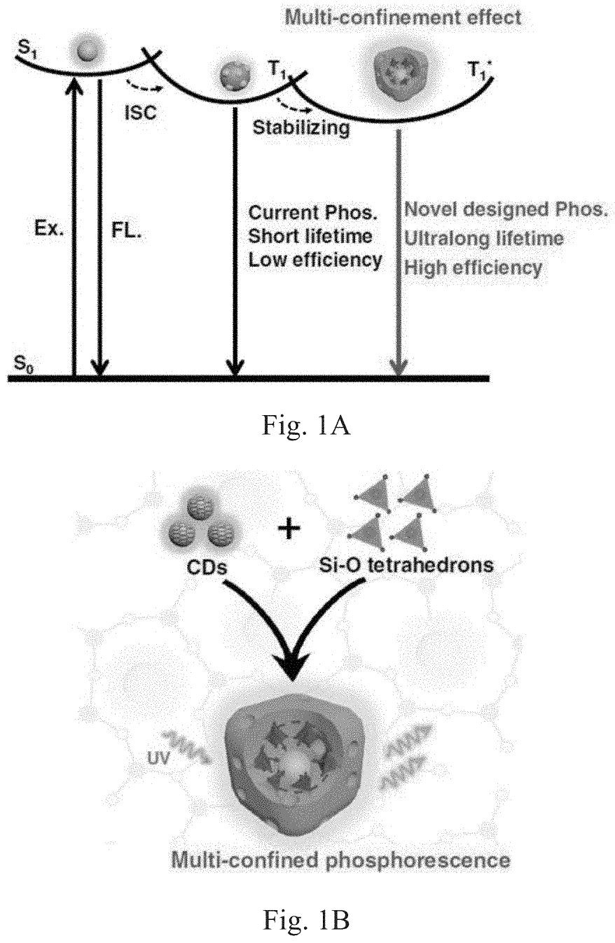

In some embodiments, the method further comprises calcination of the metal-free CDs, wherein the CDs are multi-confined by a continuous SiO₂ network composed of Si—O tetrahedrons. Multi-confinement of the carbon dots is illustrated schematically in the bottom of FIG. 1B, on the bottom right side of FIG. 2, on the right of FIG. 4A, and in FIG. 4B. The calcination can be done at a temperature of 300 to 800° C., specifically 400 to 700° C., or 500 to 650° C. In some embodiments, that calcination is done at 500 to 600° C. The calcination has been found to serve many useful purposes. It embeds the carbon dots in a continuous SiO₂ network so that the carbon dots are isolated from external phosphorescence quenching factors, such as oxygen and water vapor. Stable covalent bonds are formed between the surface of the carbon dots and the continuous SiO₂ network. This limits the degrees of freedom and molecular motion of the carbon dots, and effectively suppresses intramolecular vibrations. This phenomenon is known as the multi-confinement effect (MCE). It serves to stabilize the triplet state of the carbon dots so that long RTP lifetimes are obtained.

There are several ways to do the reacting. In some embodiments, the reacting is done by refluxing the alkaline aqueous solution at ambient pressure. In other embodiments, the reacting is done by hydrothermal treatment of the alkaline aqueous solution at greater than or equal to 100° C. in an autoclave. The hydrothermal treatment can also be done at greater than or equal to 100, 150, 200, 220, or 250° C. and less than or equal to 500, 400, 300, or 250° C. In some embodiments, the hydrothermal treatment is done at greater than or equal to 200° C. The reacting can also be done by heating the alkaline aqueous solution by microwave.

Various organic compounds can also be used as supplemental sources of carbon and other elements or functional groups in the method of making RTP metal-free carbon dots (CDs) embedded in a continuous SiO₂ network (CDs@SiO₂). The organic compounds can be added in the reacting step. For example, the reacting can be done in the presence of a polyamine, a polyalcohol, an amino alcohol, or a polyacid. In some embodiments, the reacting is done in the presence of at least one of ethylenediamine, diethylenetriamine, ethanolamine, ethylene glycol, citric acid, or polyvinyl alcohol. In some embodiments the reacting is done in the presence of a nitrogen-containing organic compound or polymer, and the resulting metal-free CDs are doped with nitrogen atoms. Any nitrogen-containing organic compound or polymer can be used as the source of nitrogen atoms. The nitrogen-containing organic compound or polymer can be, for example, a polyamine, a poly(alkylene amine), an amino alcohol, a cycloaliphatic amine, an aromatic amine, or a Mannich base. Specific examples of nitrogen-containing organic compounds or polymers include ethylene diamine (EDA), diethylenetriamine (DETA), triethylenetriamine (TETA), N,N,N′,N″,N″-pentamethyldiethylenetriamine, N,N-bis(3-aminopropyl)methylamine, ethanolamine (ETA), diethanolamine, triethanolamine, N-2-hydroxyethyl)ethylenediamine, 1,4-diaminobutane, 1,5-diaminopentane, 1,6-diaminohexane, 1,5-diamino-2-methylpentane, poly(oxypropylene diamine), poly(oxypropylene triamine), poly(glycol amine), pyrrole, pyrrolidine, piperidine, piperazine, N-aminoethylpiperazine (AEP), isophorone diamine (IPDA), 1,2-diaminocyclohexane (DACH), bis(4-aminocyclohexyl)methane (PACM), 1,3-cyclohexanebis(methylamine), 1,8-diamino-p-menthane, 4,4′-diaminodiphenylmethane (MDA), 4,4′-diaminodiphenylsulfone (4,4′-DDS), m-phenylenediamine (MPD), 4-aminophenol, diethylenetoluenediamine (DETDA), m-xylene diamine (MXDA), 1,3-bis(aminomethylcyclohexane) (1,3-BAC), or combinations thereof. FIG. 3 illustrates schematically a method for making RTP metal-free CDs@SiO₂ where the biomass is rice husks and the reacting is done in the presence of ethylene diamine (EDA) to provided nitrogen-doped carbon dots.

FIG. 3 also illustrates some of the covalent bonds that can form between the continuous SiO₂ network and the surface of the carbon dots, for example C—O—Si and C—(C═O)—O—Si. Other covalent bonds are also possible in the presence of nitrogen atoms, for example C—NH—Si and C—(C═O)—NH—Si. Hydrogen bonds between the surface of the carbon dots and the continuous SiO₂ network can also contribute to limiting the degrees of freedom and molecular motion of the carbon dots and suppressing intramolecular vibrations. Examples of possible hydrogen bonds between the surface of the carbon dots and the continuous SiO₂ network are provided below, where the examples on the right represent hydrogen bonds to a nitrogen doped surface of the carbon dots:

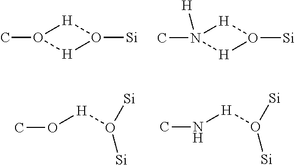

FIG. 1A illustrates schematically the energy level diagram of CDs@SiO₂ illustrating excitation and fluorescence of “naked” carbon dots (left), room temperature phosphorescence of carbon dots in a silica gel matrix (center), and room temperature phosphorescence of carbon dots multi-confined by a continuous SiO₂ network composed of Si—O tetrahedrons (right). Phosphorescence is a process in which energy absorbed by a material, for example as UV light, is later released relatively slowly in the form of visible light. As illustrated by FIG. 1A, fluorescence FL. of naked carbon dots occurs when absorption of UV light results in excitation Ex. and conversion of the low energy S₀ singlet ground state to the high energy S₁ first singlet excited state. Singlet states are states in which the electrons are paired. Fluorescence FL. is observed when the excited singlet state Si immediately relaxes back to the ground state S₀ with the emission of visible light. When the carbon dots are encapsulated by a continuous SiO₂ network composed of Si—O tetrahedrons (gel), the excited singlet state S₁ can undergo intersystem crossing ICS, i.e. conversion to the excited triplet state T₁, upon sustained excitation. In the triplet state, there are two unpaired electrons. Exited electrons can be trapped in the excited triplet state T₁ in which return to the ground state S₀ with emission of light is theoretically “forbidden”. However, the transition to the ground state S₀ can still progress at slower time scales than for fluorescence, resulting in phosphorescence (Phos.). When the carbon dots are encapsulated by the gel network, the phosphorescence has a low lifetime and proceeds with low PQE, as the energy of the triplet state T₁ can be dissipated by intramolecular motion and vibrations as well as phosphorescence. The present inventors have found than when the carbon dots are multi-confined by a continuous SiO₂ network composed of Si—O tetrahedrons by calcination, the phosphorescence has a relatively ultralong lifetime and proceeds with higher PQE. This phenomenon is called the multi-confinement effect.

FIG. 3 also illustrates the following features of the method and the RTP metal-free carbon dots. After reacting of the powder with aqueous NaOH in the presence of EDA, the resulting carbon dots fluoresce blue under UV light. Drying and grinding of the carbon dots before calcination are illustrated. The resulting blue fluorescence of the carbon dots under 365 nm UV light and weak phosphorescence when the 365 nm UV light is removed are depicted at the bottom of FIG. 3. However, the present inventors have found that when the carbon dots are calcined, strong phosphorescence and surprisingly ultralong lifetimes are obtained. The blue fluorescence of the carbon dots under 365 nm UV light and strong cyan phosphorescence when the 365 nm UV light is removed when the carbon dots are calcined are also illustrated at the bottom center of FIG. 3. Temperature effects on fluorescence and phosphorescence are illustrated at the bottom left of FIG. 3. Room temperature cyan fluorescence is observed at room temperature and below (“Low temperature”), thermally activated delayed fluorescence (TADF) is observed at “High temperature”, and a mixture RTP and TADF are observed at intermediate temperatures.

FIG. 4A illustrates schematically an arrangement of carbon dots and Si—O tetrahedrons after reacting the powder with an alkaline aqueous solution to form an aqueous solution of CDs from the biomass and Na₂SiO₃ from the source of SiO₂ and prior to gelation (left), providing no phosphorescence (left); an arrangement of carbon dots and Si—O tetrahedrons after gelation, providing weak phosphorescence (center); and an arrangement of carbon dots and Si—O tetrahedrons after calcination, in which the carbon dots are multi-confined by a continuous SiO₂ network composed of Si—O tetrahedrons, providing strong, ultralong phosphorescence (right). FIG. 4B illustrates schematically examples of covalent bonding and hydrogen bonding of the continuous SiO₂ network composed of Si—O tetrahedrons to a carbon dot. FIG. 4B, left, also illustrates a blue fluorescence spectrum, obtained under UV light, and FIG. 4B, right, also depicts a phosphorescence spectrum, obtained after removal of UV light. The chemical nature of the covalent bonds and hydrogen bonds are discussed above in relation to FIG. 3. FIG. 1B also illustrates schematically encapsulation of carbon dots by Si—O tetrahedrons in which the carbon dots are multi-confined by the continuous SiO₂ network. The multi-confinement effects results in ultralong cyan phosphorescence after exposure to UV light.

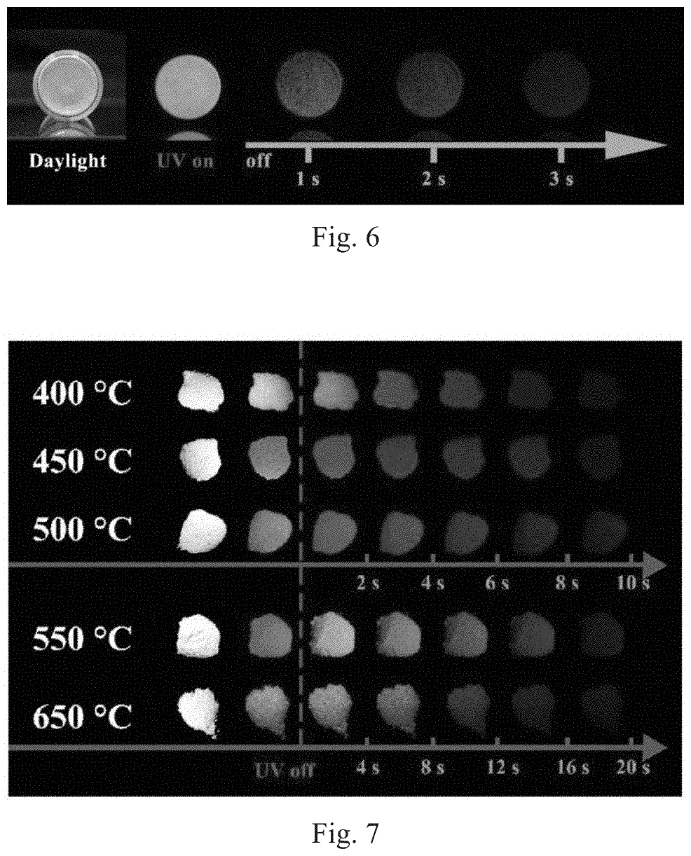

This disclosure extends to compositions comprising room temperature phosphorescent metal-free carbon dots (CDs) embedded in a continuous SiO₂ network (CDs@SiO₂) made by the method disclosed herein, wherein the method comprises: grinding biomass and a source of SiO₂ into a powder and soaking the powder with an acidic aqueous solution; washing the powder with deionized water; reacting the powder with an alkaline aqueous solution to form an aqueous solution of CDs from the biomass and Na₂SiO₃ from the source of SiO₂; adjusting the pH of the aqueous solution to 6 or less; aging the aqueous solution so that the Na₂SiO₃ forms mono-silicic acid (H₄SiO₄), which polymerizes to form a continuous SiO₂ network composed of Si—O tetrahedrons (gel); and washing the gel with deionized water and a water-soluble organic solvent, drying, and optionally grinding the metal-free CDs. Surprisingly, the resulting RTP metal-free CDs@SiO₂ exhibit a weak phosphorescent afterglow. FIG. 6 is composite of photos of CD@SiO₂ powders derived from gel without calcination in daylight (left), under UV light (254 nm, second from left), and at 1 s, 2 s, and 3 s intervals after switching off the UV light (254 nm). In particular, the CDs@SiO₂ powders derived from gel without calcination exhibit an average lifetime τ_{avg} of about 1 s to about 10 s, measured at an excitation wavelength of 365 nm by visual inspection. Within this range, the average lifetime τ_{avg} can be about 2 s to about 10 s, about 3 s to about 10 s, or about 3 s to about 5 s. In some embodiments of the CDs@SiO₂ powders derived from gel without calcination, the average lifetime τ_{avg} is about 2 s to about 5 s, measured at an excitation wavelength of 365 nm by visual inspection.

This disclosure also extends to compositions comprising room temperature phosphorescent metal-free carbon dots (CDs) embedded in a continuous SiO₂ network (CDs@SiO₂) made by the method disclosed herein, wherein the method further comprises calcination at a temperature of about 300 to about 800° C., wherein the metal-free CDs are multi-confined by the continuous SiO₂ network composed of Si—O tetrahedrons, and wherein the phosphorescence of the metal-free CDs is more intense and longer than the phosphorescence of the metal-free CDs without calcination. As discussed above, calcination embeds the carbon dots in a continuous SiO₂ network so that the carbon dots are isolated from external phosphorescence quenching factors, such as oxygen and water vapor. Stable covalent bonds are formed between the surface of the carbon dots and the continuous SiO₂ network. This limits the degrees of freedom and molecular motion of the carbon dots, and effectively suppresses intramolecular vibrations. This phenomenon is known as the multi-confinement effect (MCE). It serves to stabilize the triplet state of the carbon dots so that long RTP lifetimes are obtained. FIGS. 2-3 and 7 all depict blue fluorescence of calcined CDs@SiO₂ under UV light and cyan phosphorescence (RTP) of calcined CDs@SiO₂ when the UV light is turned off. The calcined RTP metal-free carbon dots (CDs) embedded in a continuous SiO₂ network (CDs@SiO₂) have unexpected advantageous properties. The phosphorescence lifetime of prior art carbon dot RTP phosphors are less than about 2 s, and often less than about 1 s. Prior art carbon dot RTP phosphors also often exhibit PQEs of less than about 20%. The present inventors have found that higher phosphorescence lifetimes and PQEs are possible with the present calcined RTP metal-free carbon dots (CDs) embedded in a continuous SiO₂ network (CDs@SiO₂).

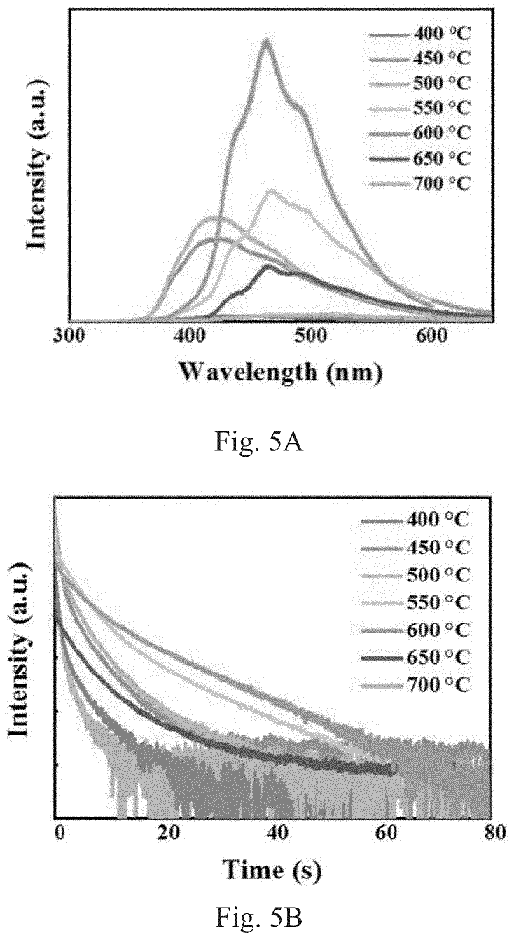

The effect of calcination temperature on phosphorescence intensity, phosphorescent lifetime, and PQE over the range of 400 to 700° C. was evaluated in Example 2. The results are summarized in FIGS. 5A and 5B, and Table 1. FIG. 5A depicts the phosphorescence spectra of CDs@SiO₂ calcined at temperatures from 400 to 700° C. As can be seen from the spectra, calcination temperature affects the intensity and wavelength range of the phosphorescence, with the highest intensity occurring over the range of about 500 to about 600° C. FIG. 5B depicts the time-resolved phosphorescence decay spectra of CDs@SiO₂ calcined at temperatures from 400 to 700° C. As can be seen from the decay spectra, calcination temperature also affects the decay rate, and therefore phosphorescence lifetimes, with the slowest decay and longest lifetimes generally occurring over the range of about 500 to about 600° C. Surprisingly, the phosphorescence lifetime was 1.74 s at a calcination temperature of 500° C., and 5.72 s at a calcination temperature of 600° C. Also, the PQE was 26.36% for a calcination temperature of 500° C. and 21.30% for a calcination temperature of 600° C., respectively. Phosphorescence lifetimes as a function of calcination temperature were also measured by visual observation. In this regard, FIG. 7 is composite of photos of CD@SiO₂ powders calcined at different temperatures in daylight (first column), under UV light (254 nm, second column), and at timed intervals after switching off the UV light (254 nm, third through seventh columns). The photos of CD@SiO₂ powders calcined at specific temperatures are arranged in horizontal rows. These results show that a visual phosphorescence lifetime of about 10 s is observed at a calcination temperature of 500° C. and a visual phosphorescence lifetime of about 20 s is observed at a calcination temperature of 600° C.

The skilled person in the art will expect that the phosphorescent lifetimes and PQEs obtained in Example 1 can be optimized through routine experimentation to obtain even higher phosphorescent lifetimes and PQEs. Thus, in some embodiments, calcined RTP metal-free carbon dots (CDs) embedded in a continuous SiO₂ network (CDs@SiO₂) exhibit at least one of: an average lifetime τ_{avg} of about 1 to about 50 s, measured at an excitation wavelength of 260 nm and an emission wavelength of 464 nm by fluorescence spectroscopy; an average lifetime τ_{avg} of about 20 s to about 100 s, measured at an excitation wavelength of 254 nm by visual inspection; or a phosphorous quantum efficiency of about 20% to about 40%, measured at an excitation wavelength of 260 nm and an emission wavelength of 464 nm by fluorescence spectroscopy.

Calcined RTP metal-free carbon dots (CDs) embedded in a continuous SiO₂ network (CDs@SiO₂) can exhibit an average lifetime τ_{avg} of about 1 to about 50 s, measured at an excitation wavelength of 260 nm and an emission wavelength of 464 nm by fluorescence spectroscopy. Within this range, the average lifetime τ_{avg} can be about 2 s to about 50 s, about 3 s to about 50 s, about 3 s to about 10 s, or about 5 s to about 10 s. (An average lifetime τ_{avg} of 5 s measured spectroscopically corresponds to an average lifetime of about 40 s to the naked eye.) In some embodiments, the average lifetime τ_{avg} is about 5 s to about 10 s. Calcined RTP metal-free carbon dots (CDs) embedded in a continuous SiO₂ network (CDs@SiO₂) can exhibit a phosphorous quantum efficiency of about 20% to about 40%, measured at an excitation wavelength of 260 nm and an emission wavelength of 464 nm by fluorescence spectroscopy. Within this range, the phosphorous quantum efficiency can be about 20% to about 30%, or about 25% to about 30%. In some embodiments, the phosphorous quantum efficiency is about 20% to about 30%. Average phosphorescence lifetimes τ_{avg} can also be measured by the naked eye. Thus, calcined RTP metal-free carbon dots (CDs) embedded in a continuous SiO₂ network (CDs@SiO₂) can exhibit an average lifetime τ_{avg} of about 20 s to about 100 s, measured at an excitation wavelength of 254 nm by visual inspection. Within this range, the average lifetime τ_{avg} can be about 20 to about 80 s, 20 s to about 60 s, or 20 s to about 40 s. In some embodiments, the average lifetime τ_{avg} is about 20 s to about 40 s, measured at an excitation wavelength of 254 nm by visual inspection.

Calcined RTP metal-free carbon dots (CDs) embedded in a continuous SiO₂ network (CDs@SiO₂) exhibit unexpected stability, as manifested by resistance to strong oxidants, solvent resistance, and stability over a pH range of 1 to 14. Thus, in some embodiments, RTP metal-free carbon dots (CDs) embedded in a continuous SiO₂ network (CDs@SiO₂), at least 85% of the average lifetime τ_{avg} is maintained after treatment for 30 min with one of a strong oxidant, a strong acid, an organic solvent, or after subjecting to a pH of 1 to 14. The strong oxidant can be, for example, aqueous hydrogen peroxide, concentrated aqueous HNO₃, or concentrated aqueous H₂SO₄. The solvent can be, for example, methanol, dimethylformamide, chloroform, or cyclohexane. The pH range can be 1 to 14. The pH can be, for example, 1, 2, 4, 6, 8, 10, 12, or 14. Supporting data is reported in Example 4 below.

It is within the ability of the skilled person in the art, to modify the RTP metal-free carbon dots (CDs) embedded in a continuous SiO₂ network (CDs@SiO₂) by routine experimentation, so that the fluorescence and/or phosphorescence are different colors. This could be accomplished, for example by doping with an appropriate additive in the reacting step, or by changing the particle size or particle size distribution of the CDs@SiO₂.

The properties of the CDs@SiO₂ disclosed herein, i.e. that they are metal-free and exhibit ultralong afterglow lifetimes (seconds versus milliseconds), high PQE, and excellent stability, make them useful for a number of end-use applications in the fields of biomedicine, optoelectronics, and optical anti-counterfeiting. The CDs@SiO₂ are especially useful under harsh conditions, i.e. exposure to oxidants, solvents, and pH extremes. The CDs@SiO₂ are useful, for example, in time-resolved anti-counterfeiting encryption systems and in fingerprint detection systems. Thus, a time-resolved anti-counterfeiting encryption system can comprise the room temperature metal-free CDs disclosed herein. The time-resolved anti-counterfeiting encryption system can be, for example, a quick response (QR) code. A time-resolved fingerprint detection system can also comprise the room temperature metal-free CDs disclosed herein.

As can be seen from the present disclosure, the present inventors have developed room temperature phosphorescent (RTP) metal-free carbon dots (CDs) multi-confined by a continuous SiO₂ network (CDs@SiO₂) and a method for making same. Multi-confinement is achieved by calcination of CDs@SiO₂ gel powders, thereby embedding the carbon dots in a rigid three-dimensional SiO₂ network composed of Si—O tetrahedrons with covalent and hydrogen-bonding of the carbon dots to the SiO₂ network. The multi-confinement results in three-dimensional spatial restriction of the degrees of freedom for triplet excited states of the carbon dots, reducing the probability of non-radiative deactivation of the triplet states and increasing phosphorescence lifetimes. Advantageously, the calcined CDs@SiO₂ are metal-free, exhibit ultralong afterglow lifetimes (seconds versus milliseconds), high PQE, and excellent stability as manifested by resistance to strong oxidants, solvent resistance, and stability over a pH range of 1 to 14.

### EXAMPLES

### Materials

Rice husks (RHs) were collected from a mill in Guangzhou, China. Glacial acetic acid (HAc) and hydrochloric acid (HCl) were purchased from Guangzhou Chemical Reagent Co., Ltd. Sodium hydroxide (NaOH) was purchased from Guangdong Guanghua Sci-Tech Co., Ltd. Deionized water was supplied by a Water Purifier Nano pure water system (Master-E, Hitech-Science tool, Shanghai, China). All reagents were analytical grade and were used without further purification.

### Characterization

UV-VIS absorption spectra were recorded on a Shimadzu UV-2550 UV-VIS spectrophotometer. X-ray powder diffraction (XRD, Rigaku) was conducted in the 2θ range from 10° to 80°. Infrared spectra were acquired from 500 to 4000 cm⁻¹ using a Nicolet Avatar 360 FTIR spectrophotometer. High-resolution transmission electron microscopy (HRTEM, JEOL-2010) images were collected to characterize the structure and morphology of the samples. Photoluminescence (PL) spectra and time-resolved decay curves were measured on a fluorescence spectrophotometer (Hitachi Model F-7000) equipped with a 150 W Xenon lamp as the excitation source. The phosphorescence quantum yields were measured by an Edinburgh FLS920 fluorescence spectrophotometer with an integrating sphere. The measurement parameters were: a microsecond pulse lamp light source; excitation wavelength: 260 nm; sample window: 50 ms; excitation period: 60 ms; delay after excitation: 0.1 ms; step size: 1 nm; and dwell time: 0.1 s. Quantum yields were calculated after measuring the excitation area and emission peak area of the background and the samples. Thermogravimetric analysis (TGA, recorded by a TG-DSC system, Netzsch) was conducted from room temperature to 1000° C. at a rate of 10° C./min in an air atmosphere. X-ray photoelectron spectroscopy (XPS) experiments were performed using a Thermo Fisher 250Xi X-ray photoelectron spectrometer with a monochromatic Al Kα X-ray source. Electron spin-resonance spectra were recorded on an electron spin resonance instrument (JES FA200, JEOL, Japan).

### Example 1. Synthesis of CDs@SiO₂ from Rice Husks

Dried rice husks (RHs, 10 g) were first ground into fine powders (200 mesh), soaked with an aqueous HCl solution (2.0 M) for 2 h under magnetic stirring, and then washed to neutral with deionized water. Subsequently, the HCl pretreated RHs were refluxed in 100 mL of aqueous NaOH solution (0.8 M) in a round bottom flask with magnetic stirring at 160° C. for 6 h to form carbon dots (CDs). The resulting mixture was filtered to obtain the CD-containing mother liquor. To effect gelation, acetic acid (HAc) was added dropwise into the aforementioned mother liquor under magnetic stirring, until the pH reached 5-6. The resulting solution was aged for 6 h to form a chocolate-brown solid gel, which was then washed with deionized water and ethanol to remove surface-attached CDs and inorganic salts. After that, the gel was dried at 60° C. in a vacuum oven for 10 h and ground into a fine powder for further use.

### Example 2. Effect of Calcination Temperature

The gel powder obtained in Example 1 was calcined in air in a muffle furnace with a ramp rate of 5° C./min to obtain multi-confined CDs@SiO₂. In order to optimize room temperature phosphorescence, a series of experiments were conducted to fabricate CDs@SiO2 phosphors at various calcination temperatures. The results are plotted in FIGS. 5A and 5B, and summarized in Table 1. As shown in Table 1, the calcined CDs@SiO₂ exhibit ultralong phosphorescent lifetimes and high quantum efficiencies. Surprisingly, room temperature phosphorescence lifetimes (τ_{avg}) of 1.74 s and 5.72 s were obtained for calcination temperatures of 500° C. and 600° C., respectively. Also surprisingly, room temperature phosphorescence quantum efficiencies of 26.36% and 21.30% were obtained for calcination temperatures of 500° C. and 600° C., respectively. Similar surprising results were obtained by visual detection of the phosphorescence. With reference to FIG. 6, an average lifetime τ_{avg} of about 20 s, measured at an excitation wavelength of 254 nm, was obtained by visual inspection.

TABLE 1
Phosphorescence lifetimes of CDs@SiO₂ calcined at temperatures ranging from 400 to 700° C.

| Calcination | | | | | | | |
|---|---|---|---|---|---|---|---|
| Temp. | τ₁ (s) | B₁ (%) | τ₂ (s) | B₂ (%) | τ₃ (s) | B₃ (%) | τ_{avg} (s) |
| 400° C. | 3.22119 | 2.64 | 0.69458 | 25.71 | 0.26035 | 71.65 | 0.99 |
| 450° C. | 3.04342 | 3.63 | 0.78804 | 27.71 | 0.32246 | 68.66 | 1.05 |
| 500° C. | 1.70267 | 26.63 | 4.34034 | 4.08 | 0.53491 | 69.29 | 1.74 |
| 550° C. | 2.98075 | 55.69 | 1.46992 | 39.65 | 9.21216 | 4.66 | 3.65 |
| 600° C. | 9.53805 | 17.10 | 3.23189 | 56.87 | 1.53309 | 26.03 | 5.72 |
| 650° C. | 6.7762 | 13.63 | 2.28087 | 77.80 | 0.35513 | 8.57 | 3.78 |
| 700° C. | 1.40049 | 4.86 | 0.36102 | 58.69 | 0.11813 | 36.45 | 0.55 |

### Example 3. Synthesis of CDs@SiO₂ Gel Powders from Rice Husks and Additives

This synthesis example is illustrated schematically by FIG. 3. Rice husks (10 g) were ground into powder and soaked in 2 M aqueous HCl solution for 2 h, washed with deionized water to neutral pH, and dried. The resulting powder was dispersed in 100 mL of aqueous NaOH (0.8 M) and mixed with 2 mL, 4 mL, 8 mL, or 10 mL of ethylenediamine (EDA) in a round bottom flask with magnetic stirring at 180° C. for 6 to form carbon dots. The resulting mixtures were filtered to obtain a CD-containing mother liquor. Aqueous HCl (3M) was added dropwise into the mother liquor until a pH of about 9 was obtained to ensure proper gelation. The resulting solution was then aged for 5 to 8 h to form a chocolate-brown gel. The gel was then washed with deionized water to remove surface-attached CDs and inorganic salts. Finally, the gel was dried at 60° C. for 10 h in an oven, to provide faint yellow CDs@SiO₂ gel powder. In separate experiments, the CD@SiO₂ gel powders were calcined in a muffle furnace in air at a temperature ramp rate of 5° C./min at temperatures of 400° C., 450° C., 500° C., 550, or 600° C. for 1 h. In these experiments, the calcination temperature of 550° C. provided the highest phosphorescence intensity. The amount of EDA added in the reacting step (2 mL, 4 mL, 8 mL, or 10 mL) affected the intensity of the phosphorescence emission, with 6 mL of EDA providing the highest intensity. In separate experiments, other additives, such as diethylenetriamine (DETA), ethanolamine (ETA), ethylene glycol (EG), and citric acid (CA) were used in place of EDA in the reacting step. For CA, 1 g was used.

### Example 4. Effect of Temperature on Phosphorescence Lifetimes of CDs@SiO₂ Calcined at 600° C.

The effects of temperature on phosphorescence lifetimes and phosphorescence quantum efficiencies were studied for CDs@SiO₂ calcined at 600° C., over the temperature range of 77 to 350 K. The results are summarized in Table 2. A phosphorescence lifetime (τ_{avg}) of 7.45 s was obtained at 77 K.

TABLE 2
Phosphorescence lifetimes of CDs@SiO₂-600 tested at different temperatures.

| Temp. (K) | τ₁ (s) | B₁ (%) | τ₂ (s) | B₂ (%) | τ₃ (s) | B₃ (%) | τ_{avg} (s) |
|---|---|---|---|---|---|---|---|
| 77 | 1566.419 | 22.08 | 306.0661 | 69.54 | 260.4767 | 8.38 | 7.45 |
| 100 | 258.9197 | 68.90 | 1623.046 | 22.27 | 288.5112 | 8.83 | 6.76 |
| 150 | 212.1957 | 7.98 | 1323.400 | 22.49 | 189.0511 | 69.53 | 6.10 |
| 200 | 794.1080 | 22.96 | 127.3645 | 7.81 | 102.9989 | 69.23 | 5.33 |
| 250 | 478.5379 | 22.75 | 61.30262 | 68.74 | 99.32996 | 8.51 | 4.90 |
| 300 | 402.7036 | 23.89 | 73.90298 | 7.29 | 58.27715 | 68.82 | 4.14 |
| 350 | 193.6204 | 24.53 | 49.30653 | 8.70 | 25.07259 | 66.77 | 3.43 |

### Example 5. Chemical Stability of CDs@SiO₂

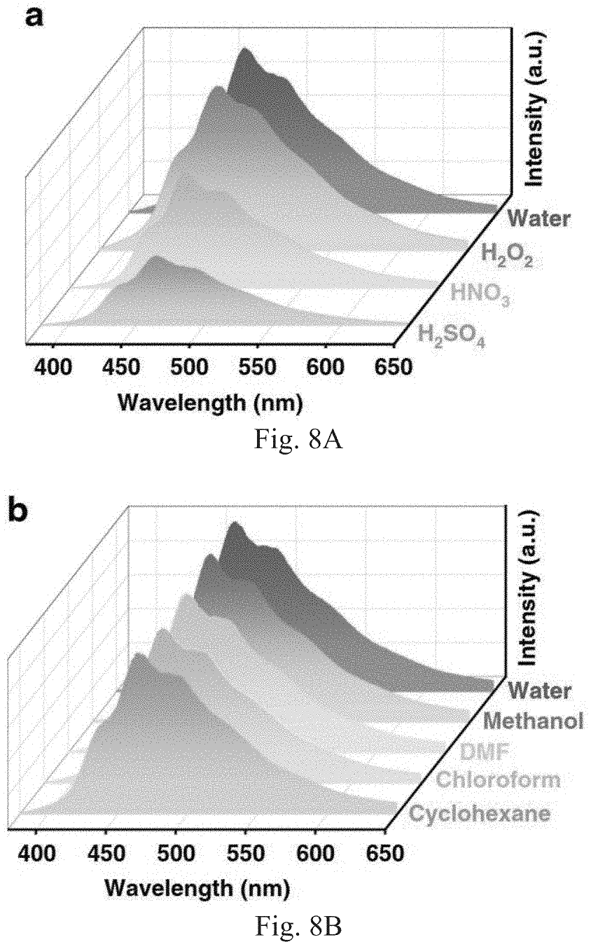

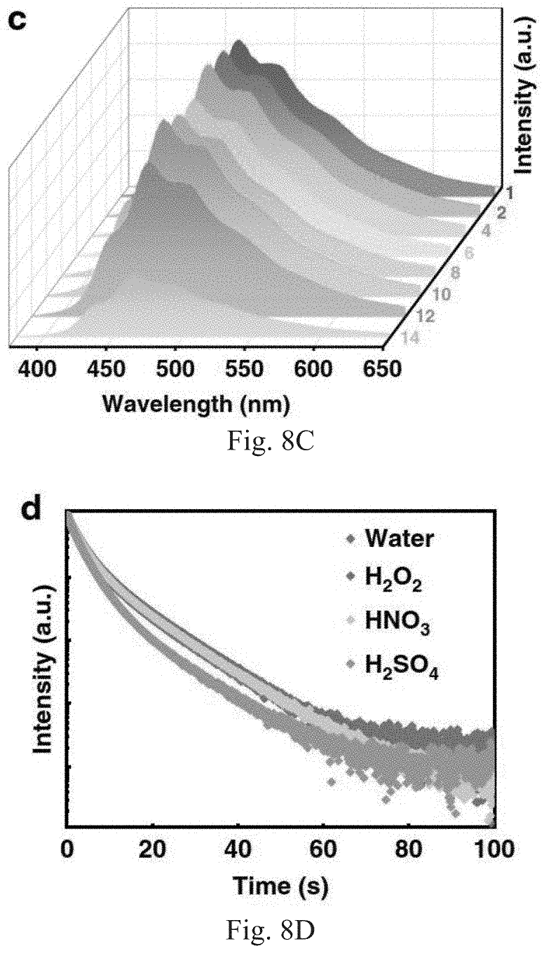

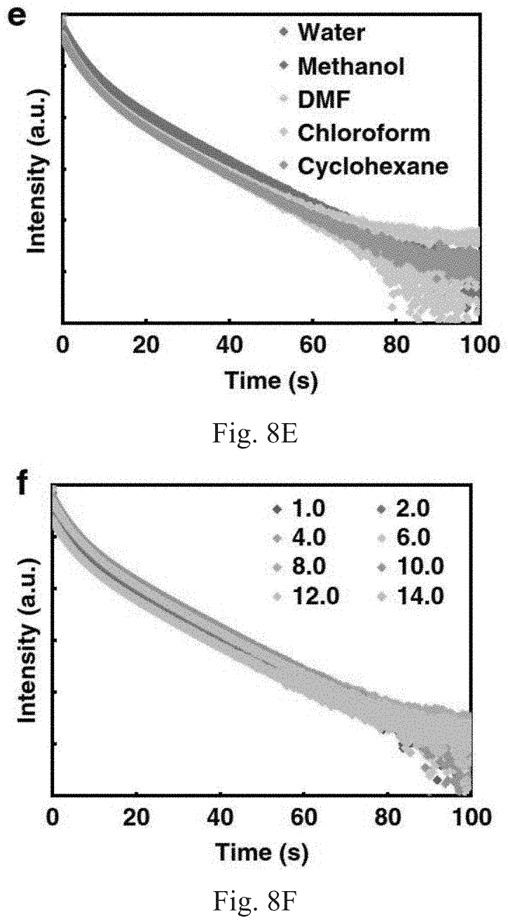

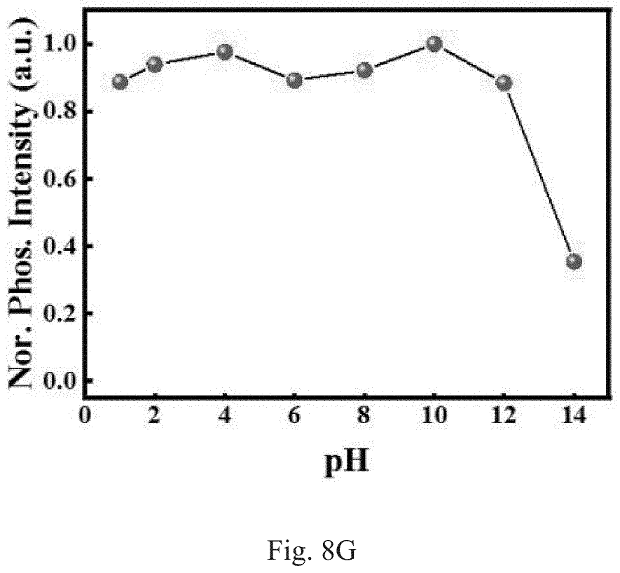

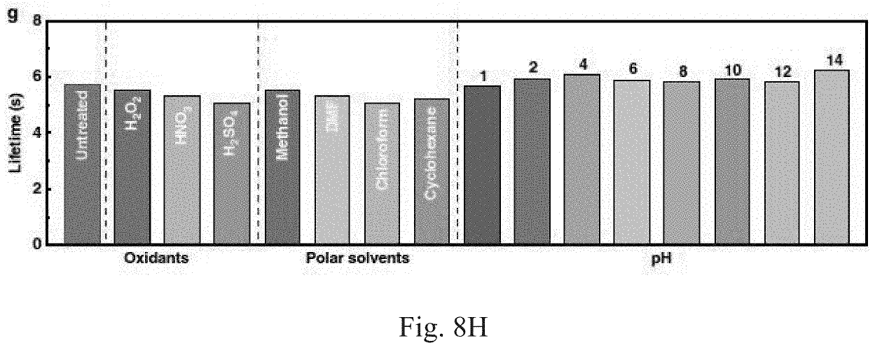

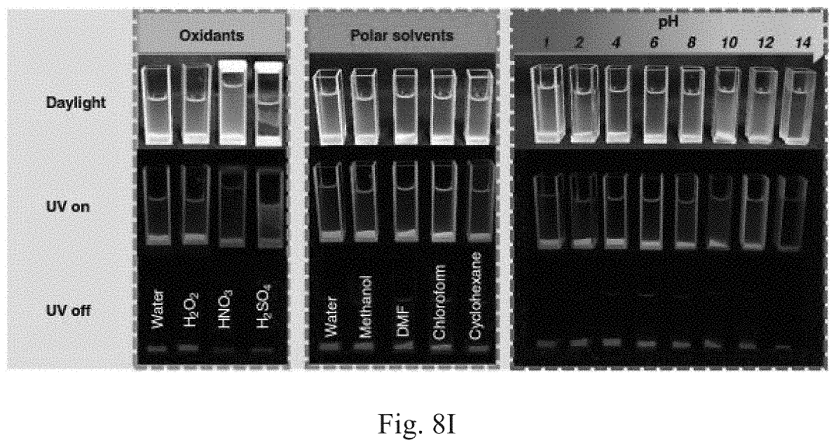

Due to multi-confinement of the carbon dots by a continuous SiO₂ network composed of Si—O tetrahedrons, calcined CDs@SiO₂ phosphors exhibit excellent anti-quenching properties and exceptional chemical stability. To assess resistance to oxidants, calcined CD@SiO₂ powders were dispersed in the strong oxidants aqueous H₂O₂ (30 wt %), concentrated HNO₃ (30 wt %), and H₂SO₄ (98 wt %), with water as a control, and ultrasonicated for 30 min. Surprisingly, although the phosphorescence lifetimes were decreased slightly by the oxidants, (FIGS. 8D and 8H), the photoluminescence was not quenched (FIG. 8A) and a long lifetime afterglow was still observed with the naked eye (FIG. 8I, left). Resistance to solvents was also assessed. Calcined CD@SiO₂ powders were dispersed in methanol, dimethylformamide (DMF), chloroform, and cyclohexane, with water has a control, and ultrasonicated for 30 min. Surprisingly, although the phosphorescence lifetimes were decreased slightly by the solvents, (FIGS. 8E and 8H), the photoluminescence was not quenched (FIG. 8B) and a long lifetime afterglow was still observed with the naked eye (FIG. 8I, center). Resistance to acid and alkaline pH was also assessed. Calcined CD@SiO₂ powders were dispersed in water at pH 1, 2, 4, 6, 8, 10, 12, and 14. Surprisingly, the CDs@SiO₂ are resistant to both strong acids and strong bases. As can be seen from FIGS. 8C and 8I, phosphorescence emission intensity only changed slightly in the pH range of 1 to 12. It is known that concentrated base can degrade silica. Therefore, strong base is expected to degrade CDs@SiO₂ phosphorescence intensity. Surprisingly, even after exposure to a strong base at a pH of 14, although the phosphorescence intensity of the CD@SiO₂ decreases (FIGS. 8C and 8I), the afterglow of the CDs@SiO₂ is relatively unchanged (FIG. 8F).

These data illustrate the unexpected stability of calcined CDs@SiO₂, due to the protective effect of the multi-confinement effect of the continuous SiO₂ network composed of Si—O tetrahedrons on the triplet state of the carbon dots. This effect reduces quenching of the carbon dots, even in harsh environments.

As used herein, “room temperature” refers to 20° C. Moreover, a temperature of 20° C. can be assumed whenever a temperature is not otherwise specified herein.

As used herein, “a” “an”, and “the” refer to both singular and plural referents unless the context clearly dictates otherwise.

The terms “about”, “substantially”, “approximately”, “circa”, and variations thereof are intended to include the degree of error associated with measurement of the particular quantity based upon the equipment available at the time of filing the application. For example, “about” a given value can include a range of ±15% or less, +10% or less, +5% or less, or +1% or less, of the given value. The value to which the modifier “about” refers is itself specifically disclosed herein.

As used herein, comparative terms, such as “high”, “low”, “strong”, “weak”, “more”, “less”, “longer”, “ultralong”, “shorter”, and the like, are used for ease of description to describe one element or feature's relationship to another element(s) or feature(s).

The following definitions are to be used for the interpretation of the claims and specification. As used herein, the terms “comprises”, “comprising”, “includes”, “including”, “has”, “having”, “contains”, “containing”, or any other variation thereof, are intended to be non-exclusive. In other words, a composition, process, method, system, or article that comprises a list of elements is not necessarily limited to only those elements but can include other elements not expressly listed or inherent in such composition, process, method, system, or article. Additionally, the terms “exemplary” and “example” are used herein to mean “serving as an example, instance or illustration.” Any embodiment described herein as “exemplary” is not necessarily to be construed as preferred or advantageous over other embodiments. The terms “at least one” and “one or more” are understood to include any integral number greater than or equal to one, i.e. one, two, three, four, etc. The term “a plurality” are understood to include any integral number greater than or equal to two, i.e. two, three, four, five, etc. “At least one of” as used herein in connection with a list means that the list is inclusive of each element individually, as well as combinations of two or more elements of the list, and combinations of at least one element of the list with like elements not named.

Chemical compounds are described using standard nomenclature.

References to numerical ranges with lower and upper endpoints herein include all numbers subsumed within the range (including fractions), whether explicitly recited or not, as well as the endpoints of the range. Thus, “1 to 5” includes 1, 2, 3, 4, and 5 when referring to, for example, a number of elements, and can also include 1.5, 2, 2.75, 3.8, or any other decimal amount when referring to, for example, quantitative measurements.

All method steps described herein can be performed in any suitable order unless otherwise indicated herein or otherwise clearly contradicted by context.

The use of any and all examples, or exemplary language (e.g., “such as” or “for example”), is intended merely to better illustrate an embodiment and does not represent a limitation on the scope of the invention or any embodiments unless indicated otherwise by context.

Any combination or permutation of features, functions and/or embodiments disclosed herein is likewise considered herein disclosed. Additional features, functions, or applications of the compositions, methods, and systems, disclosed herein will be apparent from the disclosure, particularly when read in conjunction with the appended figures. Any references listed in this disclosure are hereby incorporated by reference in their entireties.

The present disclosure includes the following numbered embodiments. The embodiments are numbered and refer to other embodiments by number, thus explicitly making logical connections between the embodiments. When a particular feature, structure, or characteristic is described in connection with an embodiment, it is within the ability of one skilled in the art to include such feature, structure, or characteristic in connection with other embodiments whether or not such combination is explicitly described elsewhere in the disclosure.

Embodiment 1. A method of making room temperature phosphorescent metal-free carbon dots (CDs) embedded in a continuous SiO₂ network (CDs@SiO₂), the method comprising: grinding biomass and a source of SiO₂ into a powder and soaking the powder with an acidic aqueous solution; washing the powder with deionized water; reacting the powder with an alkaline aqueous solution to form an aqueous solution of CDs from the biomass and Na₂SiO₃ from the source of SiO₂; reducing the pH of the aqueous solution to a value sufficient to cause gelation; aging the aqueous solution so that the Na₂SiO₃ forms mono-silicic acid (H₄SiO₄), which polymerizes to form a continuous SiO₂ network composed of Si—O tetrahedrons (gel); and washing the gel with deionized water and a water-soluble organic solvent, drying, and optionally grinding the metal-free CDs.

Embodiment 2. The method of embodiment 1, wherein the reacting is done by refluxing the alkaline aqueous solution at ambient pressure.

Embodiment 3. The method of embodiment 1, wherein the reacting is done by hydrothermal treatment of the alkaline aqueous solution at greater than or equal to 100° C. in an autoclave.

Embodiment 4. The method of embodiment 1, wherein the reacting is done by heating the alkaline aqueous solution by microwave.

Embodiment 5. The method of any of embodiments 1 to 4, further comprising calcination of the metal-free CDs, wherein the CDs are multi-confined by a continuous SiO₂ network composed of Si—O tetrahedrons.

Embodiment 6. The method of any of embodiments 1 to 5, wherein the CDs are calcined at a temperature of about 300 to about 800° C.

Embodiment 7. The method of any of embodiments 1 to 6, wherein the source of SiO₂ is at least one of silica gel, fused quartz, fumed silica, sodium metasilicate, potassium metasilicate, sodium orthosilicate, or sodium pyrosilicate.

Embodiment 8. The method of any of embodiments 1 to 6, wherein the biomass is silicon-rich biomass, which also serves as the source of SiO₂.

Embodiment 9. The method of embodiment 8, wherein the silicon-rich biomass is at least one of rice husks, wheat bran, diatoms, bamboo leaves, bamboo shoot shells, rice straw, corn stalk, oat stalk, barley awns, rice straw, indocalamus leaves, reed leaves, or siliceous spicules.

Embodiment 10. The method of embodiment 8 or 9, wherein the silicon-rich biomass comprises rice husks.

Embodiment 11. The method of any of embodiments 1 to 10, wherein the reacting is done in the presence of a polyamine, a polyalcohol, an amino alcohol, or a polyacid.

Embodiment 12. The method of any of embodiments 1 to 11, wherein the reacting is done in the presence of at least one of ethylenediamine, diethylenetriamine, ethanolamine, ethylene glycol, citric acid, or polyvinyl alcohol.

Embodiment 13. A composition comprising room temperature phosphorescent metal-free carbon dots (CDs) embedded in a continuous SiO₂ network (CDs@SiO₂) made by the method of any of embodiments 1 to 4.

Embodiment 14. The composition of metal-free CDs made by the method of embodiment 5 or 6, wherein the metal-free CDs are multi-confined by the continuous SiO₂ network composed of Si—O tetrahedrons, and wherein the phosphorescence of the metal-free CDs is more intense and longer than the phosphorescence of the metal-free CDs without calcination.

Embodiment 15. The composition of embodiment 13 or 14, wherein the reacting is done in the presence of a nitrogen-containing organic compound or polymer, and the metal-free CDs are doped with nitrogen atoms.

Embodiment 16. The composition of embodiment 13, wherein the metal-free CDs exhibit an average lifetime τ_{avg} of about 1 s to about 10 s, measured at an excitation wavelength of 365 nm by visual inspection.

Embodiment 16. The composition of embodiment 14 or 15, exhibiting at least one of: an average lifetime τavg of about 1 to about 50 s, measured at an excitation wavelength of 260 nm and an emission wavelength of 464 nm by fluorescence spectroscopy; an average lifetime τ_{avg} of about 20 s to about 100 s, measured at an excitation wavelength of 254 nm by visual inspection; or a phosphorous quantum efficiency of about 20% to about 40%, measured at an excitation wavelength of 260 nm and an emission wavelength of 464 nm by fluorescence spectroscopy.

Embodiment 17. The composition of embodiment 16, wherein at least 85% of the average lifetime τavg is maintained after treatment for 30 min with one of a strong oxidant, a strong acid, an organic solvent, or after subjecting to a pH of 1 to 14.

Embodiment 18. A time-resolved anti-counterfeiting encryption system comprising the metal-free CDs of any of embodiments 13 to 17.

Embodiment 19. The time-resolved anti-counterfeiting encryption system of embodiment 18, wherein the system is a quick response (QR) code.

Embodiment 20. A time-resolved fingerprint detection system comprising the room temperature metal-free CDs of any of embodiments 13 to 17.

While the invention has been described with reference to preferred embodiments, it will be understood by those skilled in the art that various changes may be made and equivalents may be substituted for the elements thereof without departing from the scope of the invention. In addition, many modifications may be made to adapt the teaching of the invention to a particular use, application, manufacturing conditions, use conditions, composition, medium, size, and/or materials without departing from the essential scope and spirit of the invention. Therefore, it is intended that the invention is not limited to the exemplary embodiments and best mode contemplated for carrying out this invention as described herein. Since many modifications, variations, and changes in detail can be made to the described examples, it is intended that all matters in the preceding description and shown in the accompanying figures be interpreted as illustrative and not in a limiting sense.

1. A method of making room temperature phosphorescent metal-free carbon dots (CDs) embedded in a continuous SiO₂ network (CDs@SiO₂), the method comprising:
grinding biomass and a source of SiO₂ into a powder and soaking the powder with an acidic aqueous solution;
washing the powder with deionized water;
reacting the powder with an alkaline aqueous solution to form an aqueous solution of CDs from the biomass and Na₂SiO₃ from the source of SiO₂;
lowering the pH of the aqueous solution to a value sufficient to cause gelation;
aging the aqueous solution so that the Na₂SiO₃ forms mono-silicic acid (H₄SiO₄), which polymerizes to form a continuous SiO₂ network composed of Si—O tetrahedrons (gel); and
washing the gel with deionized water and a water-soluble organic solvent, drying, and optionally grinding the metal-free CDs.

2. The method of claim 1, wherein the reacting is done by refluxing the alkaline aqueous solution at ambient pressure.

3. The method of claim 1, wherein the reacting is done by hydrothermal treatment of the alkaline aqueous solution at greater than or equal to 100° C. in an autoclave.

4. The method of claim 1, wherein the reacting is done by heating the alkaline aqueous solution by microwave.

5. The method of claim 1, further comprising calcination of the metal-free CDs, wherein the CDs are multi-confined by a continuous SiO₂ network composed of Si—O tetrahedrons.

6. The method of claim 5, wherein the CDs are calcined at a temperature of about 300 to about 800° C.

7. The method of claim 1, wherein the source of SiO₂ is at least one of silica gel, fused quartz, fumed silica, sodium metasilicate, potassium metasilicate, sodium orthosilicate, or sodium pyrosilicate.

8. The method of claim 1, wherein the biomass is silicon-rich biomass, which also serves as the source of SiO₂.

9. The method of claim 8, wherein the silicon-rich biomass is at least one of rice husks, wheat bran, diatoms, bamboo leaves, bamboo shoot shells, rice straw, corn stalk, oat stalk, barley awns, rice straw, indocalamus leaves, reed leaves, or siliceous spicules.

10. The method of claim 9, wherein the silicon-rich biomass comprises rice husks.

11. The method of claim 1, wherein the reacting is done in the presence of a polyamine, a polyalcohol, an amino alcohol, or a polyacid.

12. The method of claim 11, wherein the reacting is done in the presence of at least one of ethylenediamine, diethylenetriamine, ethanolamine, ethylene glycol, citric acid, or polyvinyl alcohol.

13. A composition comprising room temperature phosphorescent metal-free carbon dots (CDs) embedded in a continuous SiO₂ network (CDs@SiO₂) made by the method of claim 1.

14. The composition of metal-free CDs made by the method of claim 6, wherein the metal-free CDs are multi-confined by the continuous SiO₂ network composed of Si—O tetrahedrons, and wherein the phosphorescence of the metal-free CDs is more intense and longer than the phosphorescence of the metal-free CDs without calcination.

15. The composition of claim 15, wherein the reacting is done in the presence of a nitrogen-containing organic compound or polymer, and the metal-free CDs are doped with nitrogen atoms.

16. The composition of claim 13, wherein the metal-free CDs exhibit an average lifetime τ_{avg} of about 1 s to about 10 s, measured at an excitation wavelength of 365 nm by visual inspection.

16. The composition of claim 14, exhibiting at least one of:
an average lifetime τ_{avg} of about 1 to about 50 s, measured at an excitation wavelength of 260 nm and an emission wavelength of 464 nm by fluorescence spectroscopy;
an average lifetime τ_{avg} of about 20 s to about 100 s, measured at an excitation wavelength of 254 nm by visual inspection; or
a phosphorous quantum efficiency of about 20% to about 40%, measured at an excitation wavelength of 260 nm and an emission wavelength of 464 nm by fluorescence spectroscopy.

17. The composition of claim 16, wherein at least 85% of the average lifetime τ_{avg} is maintained after treatment for 30 min with one of a strong oxidant, a strong acid, an organic solvent, or after subjecting to a pH of 1 to 14.

18. A time-resolved anti-counterfeiting encryption system comprising the metal-free CDs of claim 14.

19. The time-resolved anti-counterfeiting encryption system of claim 18, wherein the system is a quick response (QR) code.

20. A time-resolved fingerprint detection system comprising the room temperature metal-free CDs of claim 14.
